(19) United States
(12) Patent Application Publication
(10) Pub. No.: US 2006/0207521 A1
(43) Pub. Date: Sep. 21, 2006

(54) Portable pet tether and method

(76) Inventor: Daniel Klauck, Chicago, IL (US)

Correspondence Address: JOAN I. NOREK,;THE LAW OFFICE OF JOAN I. NOREK, 19 N. GREEN STREET, CHICAGO, IL, 60607, US

(21) Appl. No.: 11/081,461

(22) Filed: Mar. 17, 2005

(51) Int. Cl. A01K 1/04

(52) U.S. Cl. 119/786

(57) ABSTRACT

The portable pet tether provides hands-free pet restraint during hands-on activities, such as bathing, grooming, examination and/or treatment of the pet. The portable pet tether has an anchor member and an associated or conjoined fixed-length leash member. The anchor member preferably comprised of an opposed pair of cam-lever actuated vacuum cups and a handle or bridge member bridging and connecting the pair of vacuum cups. The leash member includes a line secured to the anchor member, such as to center of the bridge member. The line is merely about a foot in length and terminates in a snap ring or other mechanical fastener suitable for attachment to the collar or the like of a pet. The portable pet tether is implemented by affixing the anchor member to a surface, such as a wall, and then attaching the pet to the end of the short line. The pet, for instance a dog, is restrained from twist or lunging during the hands-on activity, and the bather, groomer or veterinarian has the freedom to handle the dog from the side opposite the tethering.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to pet tethers. Restraining pets, particularly dogs, from wandering away from a given vicinity by means of tethering devices is well known. For instance, it is not unusual to see a dog temporarily tied to a stationary post outside of a store or other commercial establishment with its leash, which to some extent keeps the dog safe while its owner shops. The dog is restrained from walking off, and to some degree the dog is protected from someone walking off with it. A dog leash, which is routinely used when walking a dog, can be considered itself a mobile tethering device, but outside of short-term uses such as the tied-to-a-post example here, a leash is not a serviceable stationary tether. The typical dog leash has a flat cross-sectional profile and a handle at the end opposite its snap-ring connection to the dog, both of which features hamper the tying of a secure knot. In addition, a suitable pole or like structure must be found at the desired location. The use of a leash as a tether is only an expedient, the leash being at hand and already secured to the dog during a typical dog walk.

Another type of tethering device used to restrain pets, particularly dogs, is an outdoor tie-out device or stake. Such devices are typically used on the dog owner's own property when the vicinity to which the pet is to be restrained is not already bounded by sufficient fencing or the like. For instance, a tie-out or stake is often needed if a backyard is not fenced or if the dog is to be kept away from certain areas within a fenced backyard. Although a dog could be put on a long-line type of leash to keep it within certain boundaries, often there is no suitable place to fasten such a line; outdoor pipes and other objects are not suitable if the dog is of any significant size because the jarring could dislodge or otherwise damage them. Therefore stakes of one type or another are pounded into the ground and the line is fastened to the protruding end. In U.S. Pat. No. 5,022,351, issued Jun. 11, 1991, inventor Daniels, there is shown a post-type member comprised of a shaft and helical ribs that is threaded, rather than pounded, into the ground, to which is secured a housing that receives and holds a retractable leash cartridge of the type routinely used for walking a dog at variable leash lengths. The apparatus of U.S. Pat. No. 5,022,351 is portable only in a limited particularized sense. Setting up and breaking down the apparatus requires threading and unthreading the shaft into and out of the ground, and if such threading is easily performed, the ground is probably too loose to hold the stake securely. Further, the apparatus of U.S. Pat. No. 5,022,351 and similar types of tethering devices are not suitable for use indoors or on outdoor concrete surfaces and the like.

Indoors it is more common to confine a pet to a single room using a regular door or baby-gate type of device, or to confine a pet to a smaller area using a cage or a dog-crate or the like. Indoor tether devices are not typical, not only because there is no suitable place to fasten the line, but also because the line will sweep against any furniture or the like within its radius as the dog moves about.

Professional groomers use a variety of devices to restrain a pet while being groomed. For instance, in U.S. Pat. No. 5,025,572, issued Jun. 25, 1991, inventor Cordier, there is shown an elaborate groomer's platform with strap connected to a bar of the framework to maintain the animal in the desired position during grooming.

Typical dog owners do not have, and do not want, elaborate grooming tables. When the dog needs a bath, it is far more convenient and cost effective to use facilities that are available in the home. Those facilities might include a basement wash tub if it is large enough, but most often the available facilities are limited to the family bath tub. Many dogs, however, will resist being bathed, or at least try to run around shaking the water off. Bathing the dog is usually a chore requiring four hands, that is, two hands to hold the dog in place and two hands to handle the shampooing, scrubbing and rinsing. The average bathtub, and even the average wash tub, however is accessible from only a single side, making it impossible, or at least very difficult, for one person to hold the dog while the another one shampoos and rinses it. A single person can hold the dog with one hand and shampoo it with the other, but that approach is not only awkward, but also strenuous if the dog resists, and further tedious and messy if it becomes necessary to repeatedly put the dog back into the tub after it escapes. Closing the bathroom door will confine the mess to that room, but the owner and the bathroom will both require a clean-up after the dog is washed.

Bathing a dog outside, for instance in the backyard, might be done without actually placing the dog in a tub, and one person can hold the dog from one side while another shampoos and rinses from the other side. Such type of dog washing, however, is limited to reasonably clement weather and to times when two persons are both available and willing to handle the task. When outdoor dog washing is attempted by a single person, a conventional tie-out or stake apparatus will be of little use in restraining the dog because when a dog is hitched up close enough to the stake, the bathing is being done over dirt which will quickly become mud.

Other pet confinement means, such as cages, dog crates, baby-gates and the like are obviously of no value to the dog washing dilemma because they all block or obstruct access to the pet.

It would be extremely advantageous for a pet owner, particularly a dog owner, to have a means for restraining the dog during bathing that is genuinely portable, easily stored away in a drawer or cabinet, requires no assembly, can be used inside and outside, and can be readily attached to a structure on the opposite side of the dog. In a conventional bathroom in which the owner would crouch or kneel on the open long side of the bathtub to wash a dog in the tub, there is nothing on the opposite side of the dog but a tiled bathroom wall. If there is a soap holder or like structure fastened to that wall, that structure usually has no section to which a line can be tied and, in any event, using that structure to tie-off the dog risks dislodging or damaging it. On a conventional driveway or other such concrete or hard surface, there is nothing on the opposite side of any suitable spot for the dog washing except the exterior wall of the house or the garage or the garage door.

A pet owner who wants to wash his or her dog is not alone in his or her need for a means for restraining the dog at close quarters that is genuinely portable, easily stored away in a drawer or cabinet, requires no assembly, can be used inside and outside, and can be readily attached to a structure on the opposite side of the dog. Veterinarians routinely examine and treat dogs and cats of greatly varying sizes, one after another. Dogs and cats might be lifted on and off the veterinarian's examination table or cart, while some dogs might be examined and treated off the cart because of their size. Assistants to hold the pet in place during the process are not uncommon, but even a scheduled assistant is not always available, and providing assistants for all examinations and treatments is not the most cost effective approach if a simple substitute means is available. To be a realistic and practical substitute for a veterinarian assistant, and an augment to such assistant, the means for restraining the dog at close quarters must approach being as flexible and mobile as a human assistant, and therefore it must be readily portable, easily moved out of the vicinity, require little to no set up or disassembly time, usable indoors and outdoors, and capable of being positioned on the opposite side of the dog.

Further, despite any large investment in elaborate grooming and bathing facilities, most any professional pet groomer could from time to time use a means for restraining the pet at close quarters that is genuinely portable, easily stored away in a drawer or cabinet, requires no assembly, can be used inside and outside, and can be readily attached to a structure on the opposite side of the pet.

### BRIEF SUMMARY OF THE INVENTION

The present invention provides a portable pet tether comprised of an anchor member and an associated or conjoined leash member, the anchor member preferably comprised of an opposed pair of cam-lever actuated vacuum cups and a handle or bridge member bridging and connecting the pair of vacuum cups. The leash member includes a line secured to the center of the bridge member, wherein the line is merely about a foot in length and terminates in a snap ring or other mechanical fastener suitable for attachment to the collar or the like of a pet. The present invention also includes a method for implementing such a portable pet tether.

### BRIEF DESCRIPTION OF THE SEVERAL VIEWS OF THE DRAWING

FIG. 1 is a perspective view of a portable pet tether of the present invention;

FIG. 2 is an elevated side view of the portable pet tether of FIG. 1;

FIG. 3 is a bottom plan view of the portable pet tether of FIG. 1;

FIG. 4 is a top plan view of the portable pet tether of FIG. 1;

FIG. 5 is a sectional view of the portable pet tether of FIG. 1 taken along line 5-5 of FIG. 2;

FIG. 6 is a partially diagrammatic elevated side view of a portable pet tether of the present invention in use tethering a pet in a bathtub;

FIG. 7 is a partially diagrammatic top plan view of a portable pet tether of the present invention in use tethering a pet in an otherwise unconfined location;

FIG. 8 is a flow diagram of a method of tethering a pet of the present invention.

### DETAILED DESCRIPTION OF THE INVENTION

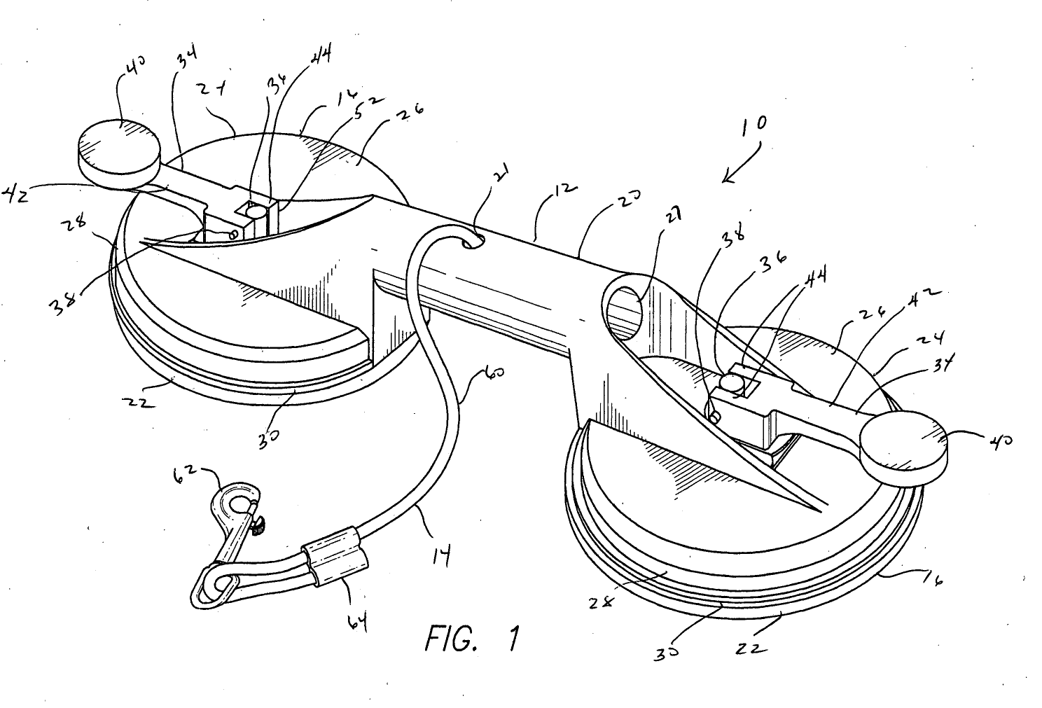

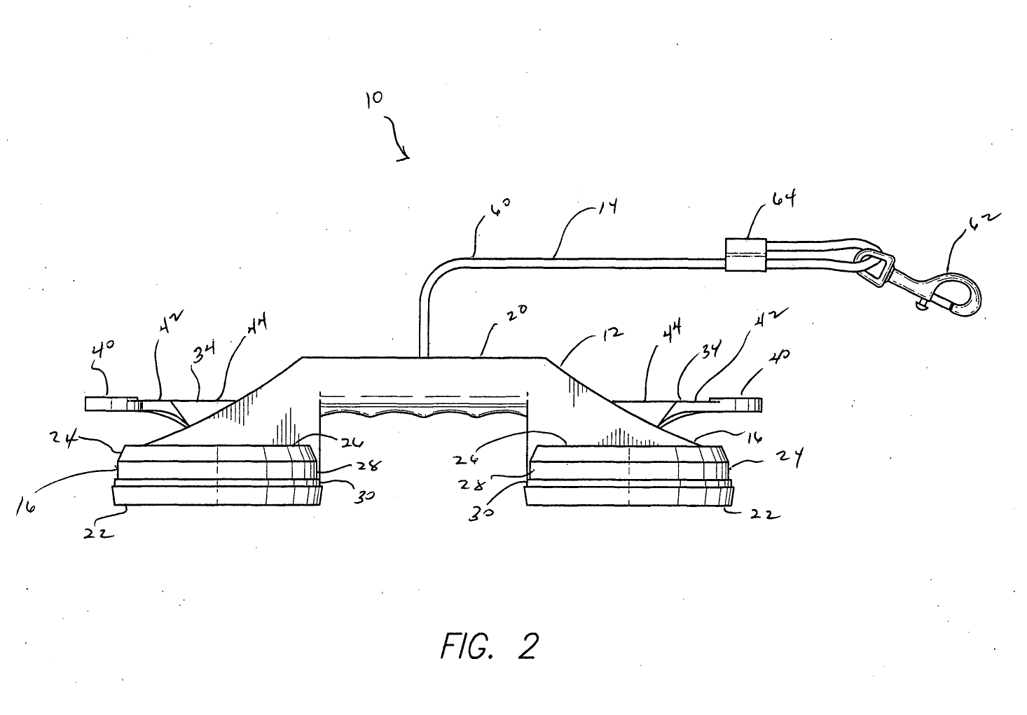

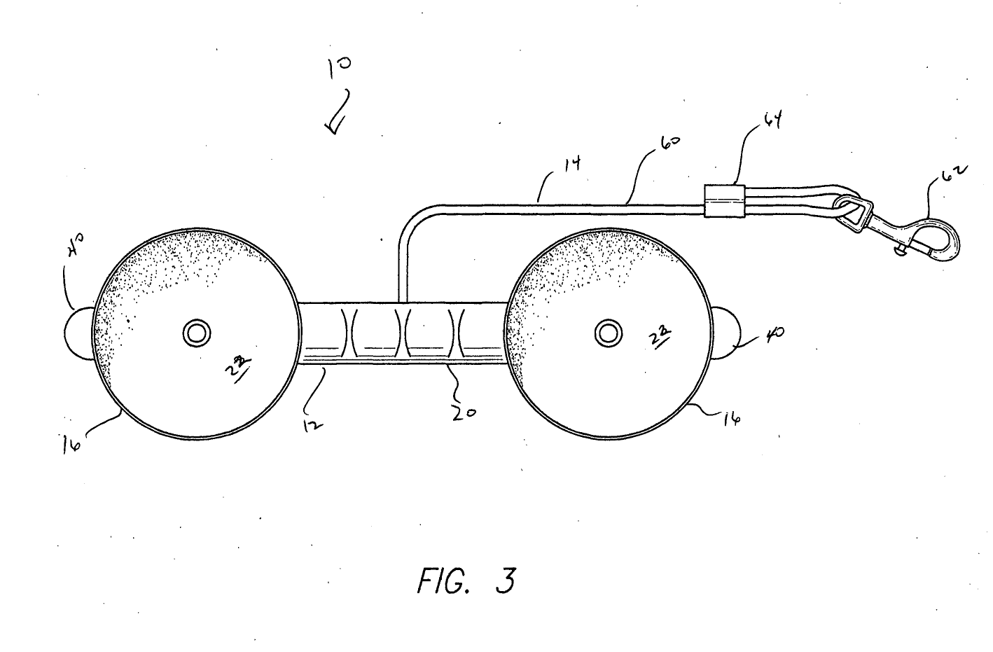

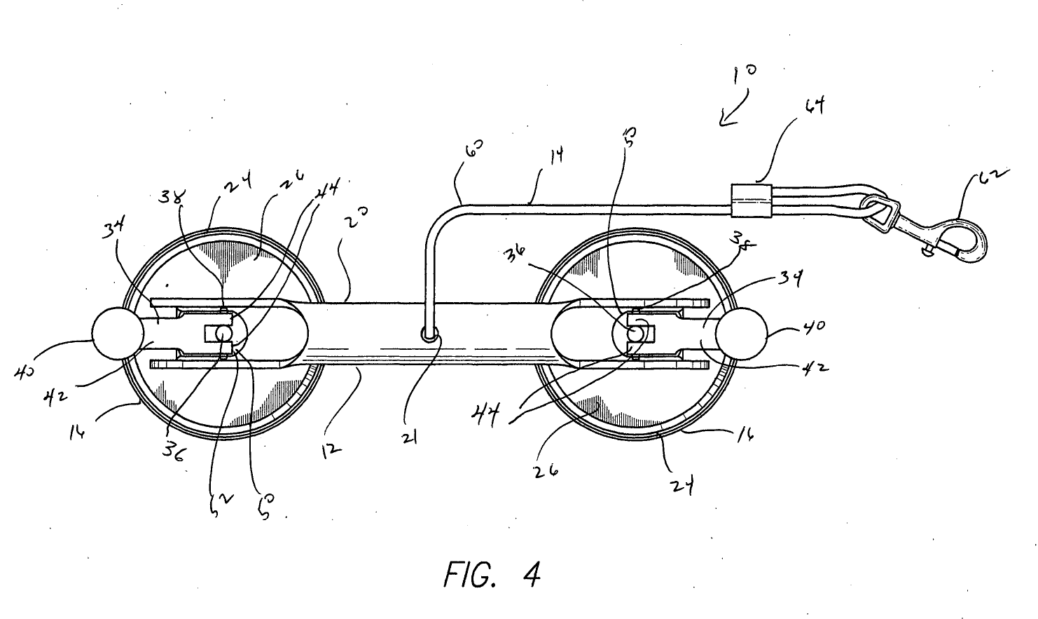

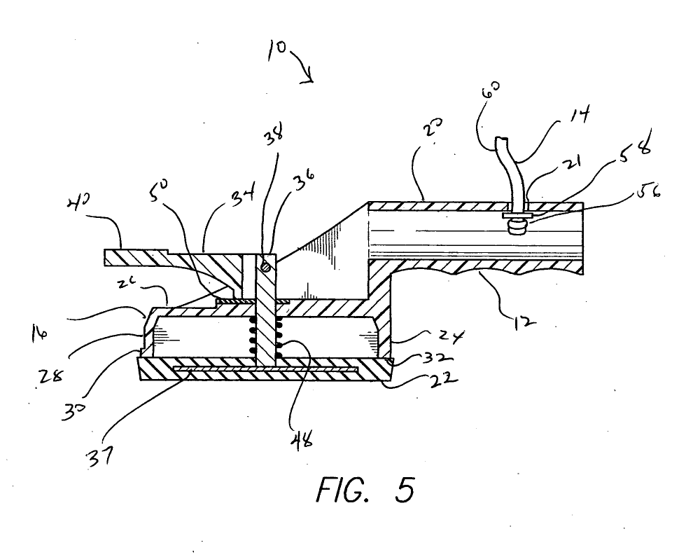

Referring now to the invention in more detail, in FIG. 1 to FIG. 5 there is shown a portable pet tether of the present invention, designated generally by the reference numeral 10. The portable pet tether 10 as illustrated in FIG. 1 to FIG. 5 is generally comprised of an anchor member 12 and an associated or conjoined fixed-length leash member 14. The portable pet tether of the present invention is devised and configured as a readily-portable device for stationary use.

The anchor member 12 as illustrated in FIG. 1 to FIG. 5 is comprised of an opposed pair of vacuum cups 16 and a handle or bridge member 20 bridging and connecting the pair of vacuum cups 16. The vacuum cups 16 as shown in FIG. 1 to FIG. 5 are mirror images of each other, namely each is identical to the other except for their respective left and right orientations. Therefore a description of one is equally applicable to the other except for their opposite left-right orientations.

Each vacuum cup 16 has a substantially circular-profiled vacuum pad 22 that, as shown, has a diameter of about 4.5 inches and a thickness of about 0.25 inches, providing a diameter to thickness ratio of about 18:1. Each vacuum pad 22 is formed of a pliable rubber or a rubber-like elastomer, namely any of a number of natural or synthetic high polymers having the unique properties of deformation (elongation or yield under stress) and elastic recovery upon the removal of the stress. Each vacuum pad 22 is a solid, rather than a foamed, pad. Each vacuum pad 22 is formed with substantially smooth, rather than rough, surfaces.

Each vacuum cup 16 has a substantially circular-profiled vacuum cup housing 24 that, as shown, has a diameter of just slightly less than 4.5 inches measured at its widest section. In more detail, the vacuum cup housing 24 of each vacuum cup 16 has a top wall 26, a continuous circular side wall 28 extending down from the top wall 26 and a continuous circular flat rim 30. The components of the vacuum cup housing 24, namely the top wall 26, continuous side wall 28 and continuous flat rim 30 form an inverted shallow cup or bowl type of structure. The vacuum cup housing 24 is positioned concentrically above the vacuum pad 22 and is open to the vacuum pad 22.

The continuous flat rim 30 of the vacuum cup housing 24 provides at its flat bottom surface a continuous circular bearing surface 32. As noted above, the substantially circular vacuum pad 22 has a diameter of about 4.5 inches and the concentrically aligned vacuum cup housing 24 has a diameter of just slightly less than 4.5 inches measured at its widest section. As shown in the embodiment of FIG. 1 to FIG. 5, the widest section of the vacuum cup housing 24 is the outer edge of the continuous flat rim 30, and in fact the diameter of the continuous flat rim 30 is about 4⅜ inches. The edge of the continuous flat rim 30 is inwardly offset from the edge of the vacuum pad 22 by about 1/16 inch about its entire circumference.

Each vacuum cup 16 has a lever-actuation assembly having a cam member 34 and a reciprocating pin 36 both journalled on a shaft 38. The cam member 34 is a lever seated on the top wall 26 of the vacuum cup housing 24 and having a upper, flattened and substantially-circular pressure plate 40, a middle neck member 42 and a pair of spaced-part leg members 44, and is journalled on the shaft 38 through each of the leg members 44 at a position inward of the side center. The upper end of the reciprocating pin 36 is disposed between the leg members 44 of the cam member 34, the shaft 38 passing through it just somewhat down from its top point, and the reciprocating pin 36 continues down through a vacuum-cup housing bore 46. The reciprocating pin 36 terminates at, and is rigidly connected to (or formed integrally with) a pin bottom plate 37 that is securely embedded in the center of the vacuum pad 22. Seated within the vacuum cup housing 24, and encircling the portion of the reciprocating pin 36 below the vacuum-cup housing bore 46, is a spiral spring member 48 that is secured to the inner surface of the top wall 26 of the vacuum cup housing 24 at its upper end and is secured at multiple points to the upper surface of the vacuum pad 22 at its lower end. The top wall 26 of the vacuum cup housing 24 as shown has an upper bearing plate 50, and it is the surface of this bearing plate 50 that the leg members 44 of the cam member 34 bear against when the cam member 34 is rotated outwardly.

The lever or cam member 34 is upright when in its release position, and is outwardly prone or prostrate when in its actuation position, as follows. When the lever or cam member 34 is upright, the bottoms of its leg members 44 are essentially standing on bearing plate 50, and the shaft 38 on which it is journalled is at its low position. The reciprocating pin 36, which is also journalled on the shaft 38, is likewise at its low or release position. When in this release position, the reciprocating pin 36 assisted by the spiral spring member 48 hold the vacuum pad 22 slightly spaced apart from the continuous flat rim 30 of the vacuum cup housing 24 whereby air is free to circulate in and out of the vacuum cup housing 24. When the lever is pressed outward, which conveniently can be done by pressing against its upper pressure plate 40, the cam member 34 rotates on its lower outward edges, which are the lower outward or bearing edges 52 of its leg members 44. The bearing edges 52 are a set distance from the shaft 38 and the reciprocating pin 36 is free to reciprocate up and down in the vacuum-cup housing bore 46 along a vertical line but is not free to move other than along that vertical line. As the lever or cam member 34 turns on the bearing edges 52, the bearing edges 52 move inward on the vacuum-cup housing bore 46 and the shaft 38 moves upward, raising the reciprocating pin 36 upwardly with it. As the reciprocating pin 36 is raised, it pulls the center of the vacuum pad 22 into the vacuum cup housing 24, and the pin's bottom plate 37 plus the attached spiral spring member 48 pull the middle section of the vacuum pad 22 into the vacuum cup housing 24, creating an area of reduced air pressure or vacuum between the pad 22 an a smooth surface if the pad 22 is pressed against such a smooth surface when the reciprocating pin 36 is raised.

In other words, as the lever or cam member 34 moves from its upright towards its prostrate or sideways position, the upper surface of the vacuum pad 22 meets and bears tightly against the continuous flat rim 30 of the vacuum cup housing 24. Because the lever or cam member 34 continues to move into its prostrate or sideways position after the circumferential edge of the vacuum pad 22 is held against the continuous flat rim 30, further outward rotation of the lever or cam member 34 raises the reciprocating pin 36 further, stretching the center section of the vacuum pad 22 farther into the vacuum cup housing 24. Therefore when the vacuum pad 22 of the vacuum cup 16 is held or pressed against a flat, sufficiently smooth surface while the lever or cam member 34 is being moved from its upright to its sideways position, a chamber is defined that it bounded by that flat surface and the outer surface of the vacuum pad 22. That chamber enlarges as the vacuum pad 22 center is drawn farther into the vacuum cup housing 24, and since the pressure prevents air from seeping between the edge of the vacuum pad 22 and the smooth surface, that chamber becomes a vacuum chamber, namely a chamber of reduced air pressure, as it is enlarged.

When the lever or cam member 34 is reversed or released by moving it back to its upright position, the space or chamber between the vacuum pad 22 and smooth surface shrinks back to its original size as the reciprocating pin 36 is lowered, and a gap again appears between the edge of the vacuum pad 22 and the continuous flat rim 30 allowing air to circulate again into the vacuum cup housing 24. The vacuum created in the chamber by the forced expansion of volume of the chamber is reversed or sufficiently reduced so that the vacuum no longer holds the vacuum cup 16 tight against the smooth surface.

While a single lever-actuated vacuum cup such as described above might be sufficient for some purposes of the present invention, such as for tethering a small pet, in preferred embodiment the anchor member 12 of the present invention includes a pair of such lever-actuated vacuum cups such as shown in FIG. 1 to FIG. 5, and described more fully below.

Referring again to FIG. 1 to FIG. 5, the handle or bridge member 20 which connects the vacuum cups 16 also holds the vacuum pad 22 of each of the two vacuum cups 16 in co-planar relationship. The handle or bridge member 20 is a substantially rigid body, preferably made of a sufficiently rigid and reasonably lightweight plastic, and preferably as shown formed as a single piece together with vacuum cup housing 24 on each side, whereby spatial distortion between these members is avoided. The handle or bridge member 20 preferably has a longitudinally extending bore 27 and a handle bore 21. The leash member 14 is preferably securely fastened to the bridge member 20 by any convenient and sufficiently secure mechanical fastener device. As shown the proximal end of the leash member 14 is merely threaded through the handle bore 21 from outside-in, and knotted so that the proximal end of the leash member 14 cannot then pass through the handle bore 21, and for additional security a washer 58 can be disposed between the knot 56 and the handle bore 21.

The leash member 14 in more detail includes a flexible line 60, such as a light rope, heavy cord or light leather strap and the like, and at its distal end a conventional mechanical fastener such as the snap ring 62 shown. The line 60 can be looped back upon itself and fastened to form a loop holding the snap ring 62, and such fastening can be accomplished by any convenient and sufficiently secure mechanical attachment devices, such as the ferule 64 shown. The length of the leash member 14 as shown is about 12 inches from the point it meets the top of the handle or bridge member 20 to the far end of its snap ring 62. The length of the leash member 14 as shown, namely about 12 inches, is also sufficient to distance the point of pet attachment, which is typically a standard attachment ring on a pet's collar, about 14 inches from the surface on which the anchor member 12 is secured via its pair of vacuum cups 16. As illustrated in FIG. 1 to FIG. 5, the distance between the outer edges of the pair of vacuum cups 16 is about 12 inches, and the height of the handle or bridge member 20 is about 2 inches.

The anchor member 12 of the portable pet tether 10 illustrated in FIG. 1 to FIG. 5 is commercially available, for instance from Harbor Freight Tools which has a chain of retail stores, located for example in Indianapolis, Ind. and Aurora, Ill., and which sells at the Internet site at harborfreight.com.

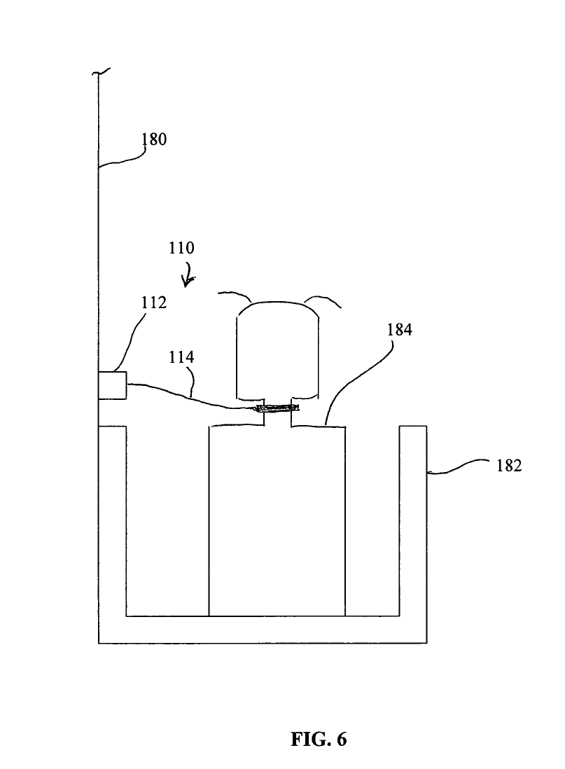

Referring now to FIG. 6 there is shown a portable pet tether 110 of the present invention having an anchor member 112 secured to a smooth surface 180 adjacent a bathtub 182 in which is tethered a medium sized pet 184, namely a dog of about 40 to 50 lb. having a height at the withers of about 19 inches. The smooth surface 180 is a typical bathroom wall adjacent a bathtub which will be formed of tile or other water-resistant material. The bathtub 182 is about 3 feet wide, and the leash member 114 of the portable pet tether 110 is about 12 inches long as measured from end to end, and its distal end, if laid out straight from the smooth surface 180 would be about 14 inches from the smooth surface 180. These dimensions are essentially those described for the portable pet tether 10 of FIG. 1 to FIG. 5 above. As is readily seen in FIG. 6, there is sufficient slack in the leash member 114 to permit the pet 184 sufficient freedom of movement to avoid discomfort, but not enough freedom of movement to lunge at the end of the leash member 114 nor to leap from the bathtub 182. The portable pet tether 110 will remain securely fastened to the smooth surface 180 even when the smooth surface 180 becomes wetted during the process of bathing the pet 184. A tether with a conventional suction cup attachment would not stick to such a bathroom wall, particularly when the wall is wet. Further, the entire portable pet tether 110 is positioned between the pet 184 and the smooth surface 180 and therefore does not obstruct the handling of the pet 184 from the side of the bathtub 182 opposite the smooth surface 180, which would be the conventional approach to bathing the pet 184.

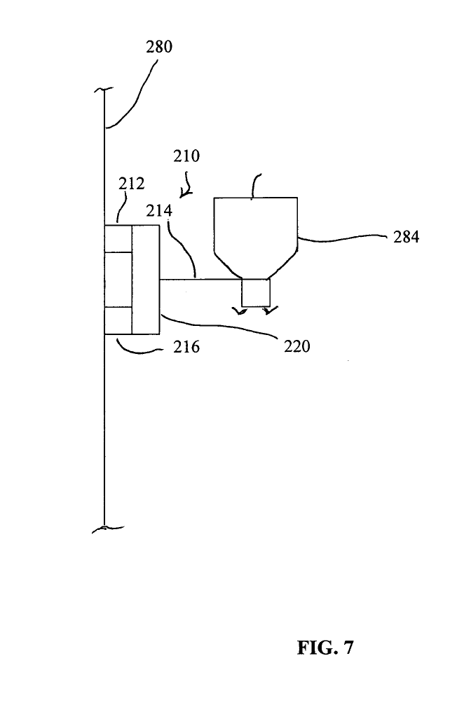

Referring now to FIG. 7 there is shown a portable pet tether 210 secured to a smooth surface 280 via its anchor member 212 with its leash member 214 extending from the approximate center of the handle or bridge member 220 with a pet 284 attached to the end of leash member 214. The pet 284 is now not confined by a structure such as the walls of a bathtub, and it can be seen that the pet 284, while not restricted in movement to the point of discomfort, is not able to lunge at the end of the leash member 214. If this smooth surface 280 were a wall of a veterinarian's examination room or a wall of a groomer's grooming room, the pet 284 would be unable to move about the room, and in fact is held essentially in place for examination or grooming from any of three open sides. In such circumstance, the pet 284 is free to yank the leash member 214 and the portable pet tether 210 of the present invention, as shown with its pair of vacuum cups 216 flanking the point of attachment of the leash member 214 on the bridge member 220, will not pull away from the smooth surface 280, as would a conventional suction cup type of attachment.

Referring now both to FIG. 6 and FIG. 7, the convenience of taking the portable pet tether 110 or portable pet tether 210 out from wherever it is stored during nonuse, such as in a small cabinet or drawer, and with a simple hand maneuver, requiring no tools nor any type of permanent installation on the smooth surface 180 or smooth surface 280, simply pressing the portable pet tether 110 or portable pet tether 210 against the smooth surface 180 or smooth surface 280, and pushing down the pair of levers (not shown) one at a time, the portable pet tether 110 or portable pet tether 210 is securely fastened to the smooth surface 180 or smooth surface 280, with the leash member 114 or leash member 214 dangling, ready for attachment to the pet. Then when finished, the pet is released, and the portable pet tether 110 or portable pet tether 210 of the present invention is merely released from the smooth surface 180 or smooth surface 280 by rasing the levers (not shown) and stowed away or moved to another location as desired.

In preferred embodiments of the present invention, the length of the leash member, as measured from the point of attachment to the anchor member to the tip of its distal end, is within the range of from about 10 to about 14 inches, and more preferably within the range of from about 11 inches to about 13 inches. In other preferred embodiments of the present invention, the reach of a portable pet tether of the present invention, as measured from the surface on which it is secured to the tip of its distal end of the leash member, should be sufficient to facilitate handling of the pet, that is, not so short that the space between the attachment surface and the pet is insufficient for handling (bathing, grooming, medically treating) and not so long that the pet has a sufficient length of line to twist or rotate its body around, or lunge, in resistance to the handling. In preferred embodiments such reach of the portable pet tether of the present invention is within the range of from about 10 to about 16 inches, and more preferably within the range of from about 12 inches to about 14 inches. In other preferred embodiments of the present invention, the distance between the centers of the vacuum pads of the anchor member is within the range of from about 6 to about 10 inches, and more preferably within the range of from about 7 inches to about 9 inches. In other preferred embodiments of the present invention, the width of the anchor member, as measured from the outer edge of one vacuum cup to the outer edge of the other vacuum cup, is within the range of from about 16 to about 18 inches, and more preferably within the range of from about 14 inches to about 10 inches. It is believed that any significant departure from these preferred dimensions will have a deleterious impact on one or more features of the present invention, including its portability features, without being balanced by any concomitant advantage.

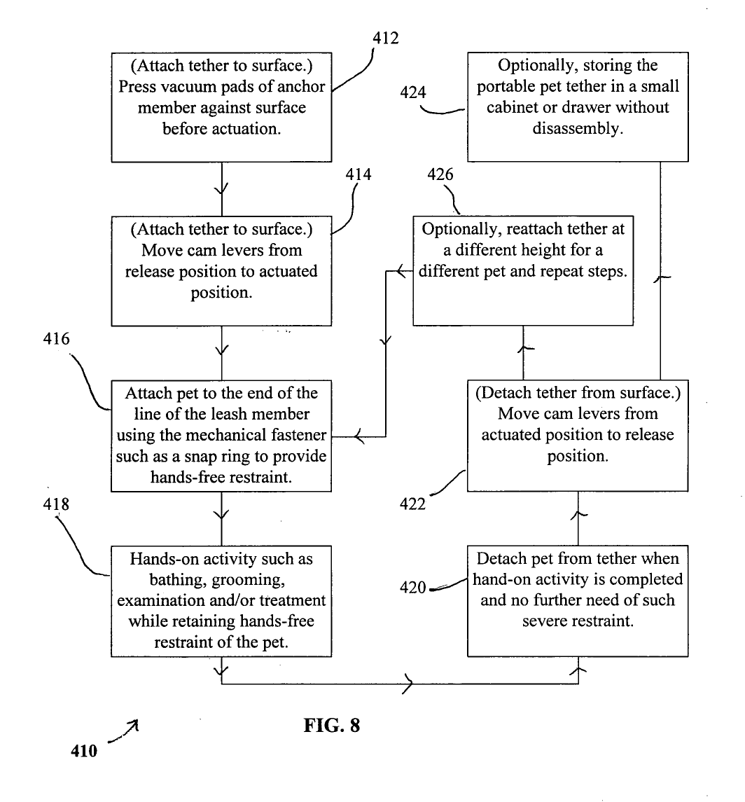

The method of the present invention 410, as shown in FIG. 8, is comprised of the steps of (step 412) pressing a portable pet tether of the present invention against a smooth surface, preferably a wall, (step 414) moving the cam levers of the portable pet tether of the present invention from the release position to the actuated position, whereby a vacuum chamber is formed at each of the vacuum cups between the vacuum pads and the smooth surface, (step 416) attaching a pet to the end of the line of the leash member, (step 418) handling the pet for bathing, grooming, medical examination and/or treatment and the like, (step 420) detaching the pet from the pet tether, (step 422) releasing the portable pet tether from the smooth surface by simply moving the cam levers from the actuation position back to the release position, and optionally (step 424) storing the portable pet tether in a small cabinet or drawer without any disassembly. Also shown is an additional optional step (step 426), wherein the surface is a substantially vertical wall surface, of replacing the portable pet tether at a different height on the vertical surface for a second pet's attachment and repeating the steps.

As seen from the drawings and the above description, the present invention provides an extremely advantageous portable pet tether for a pet owner, particularly a dog owner, which provides a means for restraining the dog during bathing that is genuinely portable, easily stored away in a drawer or cabinet, requires no assembly, can be used inside and outside, and can be readily attached to a structure on the opposite side of the dog. In a conventional bathroom in which the owner would crouch or kneel on the open long side of the bathtub to wash a dog in the tub, there is nothing on the opposite side of the dog but a tiled bathroom wall. Using the portable pet tether of the present invention, the dog is securely tethered without fastening the dog to the soap holder or like structure permanently fastened to that wall, and without risks of dislodging or damaging any bathroom fixture or the like. When the portable pet tether of the present invention is used to wash or groom a pet on a conventional driveway or other like concrete or hard surface, the portable pet tether can merely be secured to the exterior wall of the house or the garage or the garage door. In other words, the portable pet tether of the present invention provides hands-free pet restraint during a hands-on activity.

The portable pet tether of the present invention provides a means for restraining the dog or other pet at close quarters that is genuinely portable, easily stored away in a drawer or cabinet, requires no assembly, can be used inside and outside, and can be readily attached to a structure on the opposite side of the dog, that is extremely advantageous for use by veterinarians when routinely examining and treating dogs and cats of greatly varying sizes, one after another, or groomers. Instead relying on assistants to hold the pet in place during the process, the portable pet tether of the present invention provides a means for restraining the dog at close quarters that approaches being as flexible and mobile as a human assistant, and therefore readily portable, easily moved out of the vicinity, requiring little to no set up or disassembly time, usable indoors and outdoors, and can be positioned on the opposite side of the dog and readily adjusted to the height of the dog.

Further, since the portable pet tether of the present invention does not require any large investment in elaborate grooming and bathing facilities, most any pet groomer could from time to time use the portable pet tether of the present invention as a means for restraining the pet at close quarters that is genuinely portable, easily stored away in a drawer or cabinet, requires no assembly, can be used inside and outside, and can be readily attached to a structure on the opposite side of the pet.

It is well within the skill of a person in the technical field, upon becoming conversant with, or otherwise having knowledge of, the present invention, to select suitable combinations of components such as the line and mechanical fasteners, and the like, in view of the type of portable pet tether being designed and/or constructed.

The above described embodiments are exemplitive, and the terminology is employed for illustration purposes and not limitation purposes. The present invention is not limited to the combinations and subcombinations illustrated herein.

I claim:

1. A portable pet tether for hands-free pet restraint during a hands-on activity comprising:
an anchor member; and
a leash member comprised of a sufficiently short fixed-length line having a proximal end and a distal end and being affixed to said anchor member at about said proximal end, and a mechanical fastener affixed to said line at about said distal end.

2. The portable pet tether of claim 1 wherein said anchor member is comprised of at least a first lever-actuated vacuum cup.

3. The portable pet tether of claim 1 wherein said anchor member is comprised of a first and a second lever-actuated vacuum cup and a bridge member interconnecting said first and second lever-actuated vacuum cups,
said first vacuum cup having a first vacuum pad;
said second vacuum cup having a second vacuum pad; and
said first and said second vacuum pads being substantially coplanar.

4. The portable pet tether of claim 1 wherein said mechanical fastener is a snap ring.

5. The portable pet tether of claim 1 wherein said anchor member is comprised of a first and a second lever-actuated vacuum cup and a bridge member interconnecting said first and second lever-actuated vacuum cups; and
wherein said fixed-length line is affixed to said bridge member of said anchor member.

6. The portable pet tether of claim 1 wherein said fixed-length line has a length of from about 10 to about 14 inches.

7. The portable pet tether of claim 1 wherein said anchor member is comprised of a first and a second lever-actuated vacuum cup and a bridge member interconnecting said first and second lever-actuated vacuum cups,
said first vacuum cup having a first vacuum pad;
said second vacuum cup having a second vacuum pad;
said first and said second vacuum pads being substantially coplanar; and
wherein the reach of said pet tether as measured from the plane of said vacuum pads to said distal end of said line is from about 10 to about 16 inches.

8. A portable pet tether for hands-free pet restraint during pet bathing, grooming, examination or treatment comprising:
an anchor member having means for affixation to a stationary surface; and
a leash member affixed to said anchor member and comprised of a flexible fixed-length line and a mechanical fastener, wherein said line and said mechanical fastener are interconnected.

9. The portable pet tether of claim 8 wherein said anchor member is comprised of a first and a second lever-actuated vacuum cup and a bridge member interconnecting said first and second lever-actuated vacuum cups,
said first vacuum cup having a first vacuum pad;
said second vacuum cup having a second vacuum pad; and
said first and said second vacuum pads being substantially coplanar.

10. The portable pet tether of claim 8 wherein said mechanical fastener is a snap ring.

11. The portable pet tether of claim 8 wherein said anchor member is comprised of a first and a second lever-actuated vacuum cup and a bridge member interconnecting said first and second lever-actuated vacuum cups; and
wherein said fixed-length line is affixed to said bridge member of said anchor member.

12. The portable pet tether of claim 8 wherein said fixed-length line has a length of from about 10 to about 14 inches.

13. The portable pet tether of claim 8 wherein said anchor member is comprised of a first and a second lever-actuated vacuum cup and a bridge member interconnecting said first and second lever-actuated vacuum cups,
said first vacuum cup having a first vacuum pad;
said second vacuum cup having a second vacuum pad;
said first and said second vacuum pads being substantially coplanar; and
wherein the reach of said pet tether as measured from the plane of said vacuum pads to said distal end of said line is from about 10 to about 16 inches.

14. A method of hands-free pet restraint during a hands-on activity comprising of the steps of:
affixing a portable pet tether having an anchor member and a leash member having a sufficiently short fixed-length line, said line having a proximal end and a distal end, said line affixed to said anchor member at about said proximal end, and a mechanical fastener affixed to said line at about said distal end, to a surface by affixation of said anchor member to said surface;
tethering a first pet with said pet tether by attaching said first pet to said mechanical fastener of said line of said pet tether;
handling said first pet while tethered with said pet tether;
detaching said first pet from said pet tether; and
releasing said portable pet tether from said surface.

15. The method of claim 14 wherein said anchor member of said pet tether is comprised of a pair of lever-actuated vacuum cups each having a vacuum pad and being interconnected by a bridge member, further including the sub-steps of:
affixing said anchor member of said portable pet tether to said surface by grasping said bridge member and a pressing said vacuum pads against said surface while moving said levers from a release position to an actuation position; and
releasing said anchor member from said surface by moving said levers from said actuation position said release position.

16. The method of claim 14 further including the step of, after releasing said anchor member from said surface,
storing said portable pet tether in a small cabinet or drawer without disassembly.

17. The method of claim 14 wherein said surface is a substantially vertical wall surface, further including the sub-steps of
determining at least the approximaate height of said first pet prior to affixing said portable pet tether to said substantially vertical wall surface; and
affixing said portable pet tether to said substantially vertical wall surface at a first height.

18. The method of claim 17 further including the steps of, after releasing said anchor member from said surface,
affixing said anchor member of said portable pet tether to said substantially vertical wall surface at a second height; and
attaching a second pet to said pet tether by attaching said second pet to said mechanical fastener of said line of said pet tether;
handling said second pet while tethered with said pet tether;
detaching said second pet from said pet tether.
